(19) United States
(12) Patent Application Publication
(10) Pub. No.: US 2024/0203185 A1
(43) Pub. Date: Jun. 20, 2024

(54) POSITIONING SYSTEM, ACCESS CONTROL SYSTEM, AND POSITIONING METHOD

(71) Applicant: ALPS ALPINE CO., LTD., Tokyo (JP)

(72) Inventors: Taiki IGARASHI, Miyagi (JP); Daisuke TAKAI, Tokyo (JP)

(21) Appl. No.: 18/541,408

(22) Filed: Dec. 15, 2023

(30) Foreign Application Priority Data
Dec. 20, 2022 (JP) 2022-203540

(51) Int. Cl. G07C 9/28; G01S 5/02; G07C 9/22

(52) U.S. Cl. CPC G07C 9/28; G01S 5/0295; G07C 9/22; G07C 2209/08

(57) ABSTRACT

A positioning system includes: a transmitting and receiving part having multiple antennas and positioned overhead in a positioning target area with a side entrance; a distance calculation part configured to calculate a distance between a communication device that can move in the positioning target area, and the transmitting and receiving part, based on results gained from signals of multiple frequencies transmitted bidirectionally between the communication device and the transmitting and receiving part; an angle calculation part configured to calculate an angle that indicates a position of the communication device with respect to the transmitting and receiving part, based on a phase difference between the signals received by the antennas of the transmitting and receiving part; and a determining part configured to determine whether or not the communication device is approaching the side entrance based on the distance and angle calculated by the distance calculation part and the angle calculation part.

### CROSS-REFERENCE TO RELATED APPLICATION

This application is based on and claims priority to Japanese Patent Application No. 2022-203540, filed on Dec. 20, 2022, the entire contents s of which are incorporated herein by reference.

### BACKGROUND OF THE INVENTION

### 1. Field of the Invention

The present disclosure relates to a positioning system, an access control system, and a positioning method.

### 2. Description of the Related Art

Heretofore, there is an information output system with: an information generation part that, when there are a first area and a second area neighboring the first area, generates first information related to the position of a mobile communication terminal in the first area, based on a radio signal received from the mobile communication terminal located in the first area; and an output part that outputs second information related to movement of the mobile communication terminal from the first area to the second area, based on the first information. The first information and the second information are information related to the received signal strength indication (RSSI) of radio signals (see, for example, Patent Document 1).

### CITATION LIST

### Patent Document

Patent Document 1: Unexamined Japanese Patent Application Publication No. 2018-179952

### SUMMARY OF THE INVENTION

### Technical Problem

The above conventional information output system (positioning system) determines in which one of the first area and the second area the mobile communication terminal (communication device) is located, based on the received signal strength indication (RSSI) of radio signals. The radio signals may arrive straight as direct-path signals without undergoing reflection, or the radio signals may undergo reflection off structures such as building walls and arrive as multi-path signals. Consequently, calculations based on received signal strength indications show significant errors due to multi-path signals, making it difficult to calculate the position of a communication device accurately.

It is therefore an object of the present disclosure to provide a positioning system, an access control system, and a positioning method whereby the position of a communication device can be calculated accurately.

### Solution to Problem

According to an embodiment of the present disclosure, a positioning system includes: a transmitting and receiving part having a plurality of antennas and positioned overhead in a positioning target area where there is a side entrance; a distance calculation part configured to calculate a distance between a communication device that can move in the positioning target area, and the transmitting and receiving part, based on results gained from signals of a plurality of frequencies transmitted bidirectionally between the communication device and the transmitting and receiving part; an angle calculation part configured to calculate an angle that indicates a position of the communication device with respect to the transmitting and receiving part, based on a phase difference between the signals received by the plurality of antennas of the transmitting and receiving part; and a determining part configured to determine whether or not the communication device is approaching the side entrance based on the distance calculated by the distance calculation part and the angle calculated by the angle calculation part.

### Advantageous Effects of the Invention

It is therefore possible to provide a positioning system, an access control system, and a positioning method whereby the position of a communication device can be calculated accurately.

### BRIEF DESCRIPTION OF THE DRAWINGS

FIG. 1 is a diagram that shows an example structure of a space in which an access control system including a positioning system according to an embodiment is installed;

FIG. 2 is a plan view that shows an example of a positioning target area;

FIG. 3 is a diagram that shows example structures of an access control system and a smartphone;

FIG. 4 is a diagram that shows an example of a determining area;

FIG. 5 is a flowchart that shows examples of process steps (part 1) executed by a control device of an access control system; and

FIG. 6 is a flowchart that shows examples of process steps (part 2) executed by a control device of an access control system.

### DETAILED DESCRIPTION OF THE PREFERRED EMBODIMENTS

Now, an embodiment using the positioning system, access control system, and positioning method according to the present disclosure will be described below.

### Embodiment

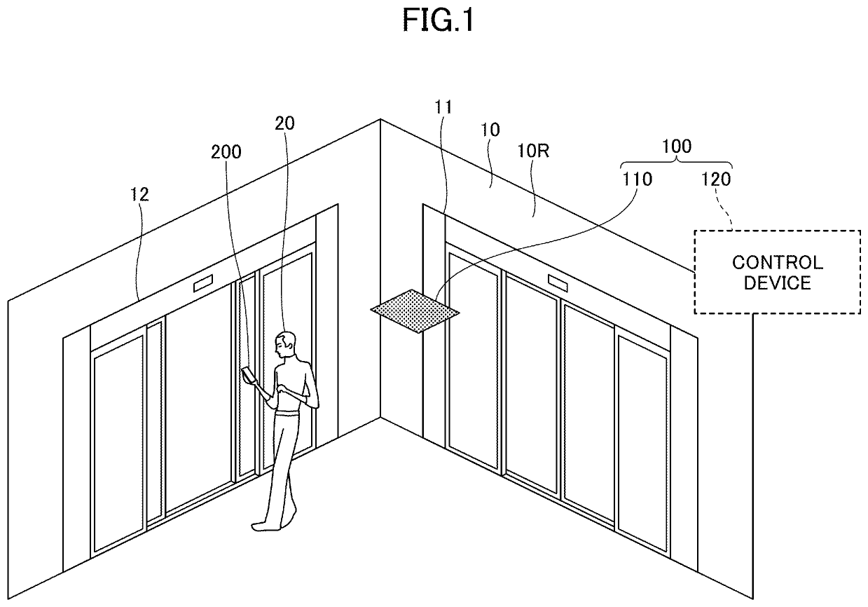

FIG. 1 is a diagram that shows an example structure of a space in which an access control system 100 including a positioning system according to an embodiment is installed.

Walls 10 are provided with automatic gates 11 and 12. The automatic gates 11 and 12 are examples of gates provided at side entrances. The side entrances where the automatic gates 11 and 12 are installed are the only side entrance for entering the space inside the walls 10 from the space outside the walls 10, and the only side entrance for exiting from the space inside the walls 10 to the space outside the walls 10. The walls 10 may be various walls, such as walls surrounding a room, walls separating the outside and the inside of a building, and so forth. Below, an example in which the walls 10 surround a room 10R will be described.

The access control system 100 controls entry to/exit from the room 10R by performing an authentication by using the identifier of a smartphone 200 that a user 20 carries with him/her, and controlling the automatic gates 11 and 12 to open and close. The user 20 is an example of a moving object that can move together with the smartphone 200, and the smartphone 200 is an example of a communication device.

When a smartphone 200 approaching the automatic gate 11 or 12 is detected, the access control system 100 performs an authentication process, and, when the authentication is successfully completed, the access control system 100 opens the automatic gate 11 or 12. The access control system 100 performs the authentication process every time a smartphone 200 approaches the automatic gate 11 or 12.

The access control system 100 specifies the position of the smartphone 200 of the user 20 in the room 10R based on the distance and angles of the smartphone 200 with respect to a reference point, which are determined in a distance calculation process and an angle calculation process, thereby detecting when the user 20 comes in front of the automatic gate 11 or 12. The reference point is the center point of a transmitting and receiving part 110 of the access control system 100. Note that, instead of performing an authentication process using the identifier of the user 20's smartphone 200, the access control system 100 may perform an authentication process using biological information of the user 20 (for example, face verification, fingerprint verification, etc.), or perform an authentication process using identification information that the user 20 carries with him/her (employee ID, student ID, etc.).

In this one example, the automatic gate 11 is closed and the automatic gate 12 is open. Closing the automatic gates 11 and 12 means closing and locking the automatic gates 11 and 12. Also, opening the automatic gates 11 and 12 means unlocking and opening the automatic gates 11 and 12. That is, when the access control system 100 controls the automatic gates 11 and 12 to open and close, the access control system 100 locks and unlocks the automatic gates 11 and 12 on a switching basis.

Note that, although an example will be described here in which the automatic gates 11 and 12 are provided in the room 10R, it is also possible to provide a manual gate that the user 20 can touch and open/close with his/her hand, instead of at least one of the automatic gates 11 and 12. In the event a manual gate is provided in the room 10R thus, the access control system 100 has only to likewise lock and unlock the manual gate on a switching basis.

### <Structure of Access Control System 100>

The access control system 100 includes a transmitting and receiving part 110 and a control device 120.

### <Transmitting and Receiving Part 110>

The transmitting and receiving part 110 is, for example, a device that is provided in the ceiling of the room 10R, and that can communicate with the smartphone 200 in a communicable area covering substantially the entire area in the room 10R including in front of the automatic gates 11 and 12. Note that the transmitting and receiving part 110 needs only to have its communicable area at least in a three-dimensional area in front of the automatic gates 11 and 12 in the room 10R. Therefore, the location to place the transmitting and receiving part 110 is not limited to the ceiling of the room 10R, and, for example, the transmitting and receiving part 110 may be suspended from the ceiling. The transmitting and receiving part 110 is preferably positioned overhead in the room 10R. “Overhead in the room 10” refers to a position that is higher than the average person's height, and, for example, a position 2 meters or more above the ground/floor may be suitable.

### <Control Device 120>

The control device 120 is connected to the transmitting and receiving part 110 by a cable or the like, structured to be capable of data communication with the transmitting and receiving part 110, and provided inside or outside the room 10R. Note that the control device 120 may be structured to be capable of wireless data communication with the transmitting and receiving part 110. In this case, the method of wireless communication between the control device 120 and the transmitting and receiving part 110 has only to be different from the method of wireless communication between the smartphone 200 and the transmitting and receiving part 110.

The control device 120 performs data communication with the smartphone 200 via the transmitting and receiving part 110 and performs a TOA (Time of Arrival)-based distance calculation process and an AOA (Angle of Arrival)-based angle calculation process, thereby calculating, three-dimensionally, the position of the smartphone 200 with respect to the transmitting and receiving part 110 in the room 10R.

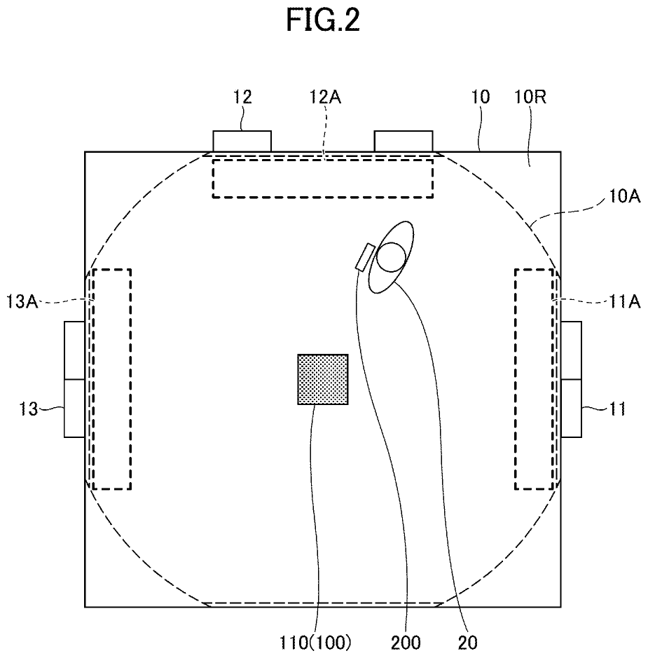

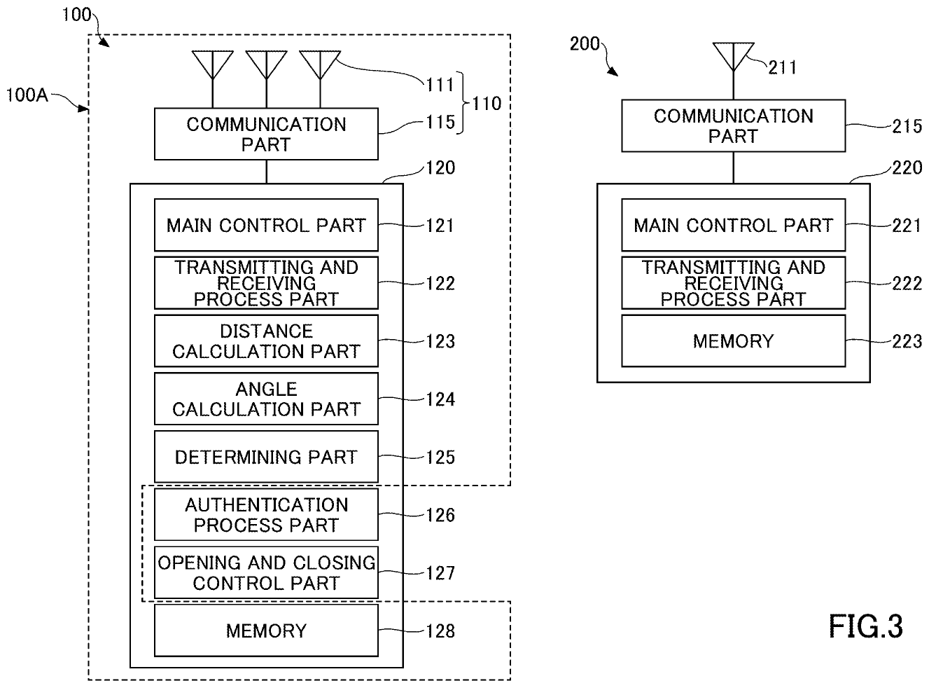

The area in which the transmitting and receiving part 110 can communicate with the smartphone 200 is a positioning target area, which is an area in which the positioning system included in the access control system 100 can locate the smartphone 200. That is, the area in which the transmitting and receiving part 110 can communicate is the same as the positioning target area of the positioning system. The positioning target area will be described later with reference to FIG. 2, and the distance calculation process and angle calculation process will be described later in detail with reference to FIG. 3. Also, the positioning system according to the embodiment will be described later with reference to FIG. 3.

### <Positioning Target Area 10A>

FIG. 2 is a plan view that shows an example of a positioning target area 10A. FIG. 2 is a transparent plan view of the room 10R seen from above the ceiling. The transmitting and receiving part 110 is provided at the center of the ceiling of the room 10R. Also, in FIG. 2, an automatic gate 13 is shown in addition to the automatic gates 11 and 12. The automatic gate 13 is substantially the same as the automatic gates 11 and 12, and provided opposite the automatic gate 11. In FIG. 2, the automatic gate 13 is closed.

The positioning target area 10A is a three-dimensional area that covers substantially the entirety of the room 10R, and includes determining areas 11A to 13A provided in front of the automatic gates 11 to 13. The determining areas 11A to 13A are all three-dimensional areas that the access control system 100 uses when determining whether or not the smartphone 200 is present in front of the automatic gates 11 to 13.

Also, the automatic gates 11 to 13 are the only side entrances for entering the room 10R from outside the room 10R. Therefore, in order to exit the room 10R, it is necessary to walk through the automatic gate 11, 12, or 13. The automatic gate 11 opens when the access control system 100 determines that the smartphone 200 is present in the determining area 11A and the authentication is completed successfully. Similarly, the automatic gate 12 opens when the access control system 100 determines that the smartphone 200 is present in the determining area 12A and the authentication is completed successfully. The automatic gate 13 opens when the access control system 100 determines that the smartphone 200 is present in the determining area 13A and the authentication is completed successfully.

Note that, in order to open the automatic gate 11, 12, or 13 from the outside of the room 10R, the process of determining whether or not a smartphone 200 is approaching and the authentication process may be performed by an access control system that is substantially the same as the access control system 100, or the authentication and other processes may be performed based on different methods, or the authentication and other processes may be not performed.

### <Structure of Access Control System 100 and Smartphone 200>

FIG. 3 is a diagram that shows example structures of the access control system 100 and the smartphone 200. The access control system 100 and the smartphone 200 perform packet communication based on Bluetooth (registered trademark) low energy, for example.

### <Structure of Access Control System 100>

The access control system 100 includes a transmitting and receiving part 110 and a control device 120. The transmitting and receiving part 110 has three antennas 111 and a communication part 115. The control device 120 is constituted by an MCU (Micro Controller Unit).

### <Antennas 111>

The antennas 111 are connected to the communication part 115 and receive signals transmitted from the smartphone 200. Note that, although FIG. 1 shows a structure in which the access control system 100 has three antennas 111, the access control system 100 may have four or more antennas 111 as well. The three antennas 111 are structured such that two antennas are placed on the first one of two axes that are orthogonal to each other, two antennas are placed on the second one of the two axes that are orthogonal to each other, and one of these antennas is placed on the first axis and on the second axis in common.

### <Communication Part 115>

The communication part 115 includes an AFE (Analog Front End), an AD (Analog to Digital) converter, and so forth. The communication part 115 performs signal processing such as AD conversion on the signals that the antennas 111 receive from the smartphone 200, and outputs them to the control device 120.

### <Control Device 120>

The control device 120 includes a main control part 121, a transmitting and receiving process part 122, a distance calculation part 123, an angle calculation part 124, a determining part 125, an authentication process part 126, an opening and closing control part 127, and a memory 128. The opening and closing control part 127 is an example of the locking and unlocking part that is provided in the automatic gates 11 to 13, and that locks and unlocks the automatic gates 11 to 13 on a switching basis. The memory 128 is an example of the storage part.

The control device 120 is implemented, for example, by a microcomputer including a CPU (Central Processing part), a RAM (Random Access Memory), a ROM (Read Only Memory), an internal bus, and so forth. The main control part 121, transmitting and receiving process part 122, distance calculation part 123, angle calculation part 124, determining part 125, authentication process part 126, and opening and closing control part 127 are functional blocks that control the functions of programs that the control device 120 executes. Also, the memory 128 is a functional representation of the memory of the control device 120.

### <Structure of Positioning System 100A>

Here, the positioning system 100A according to the embodiment has a structure in which the authentication process part 126 and the opening and closing control part 127 are omitted from the access control system 100. Therefore, in FIG. 3, the components of the positioning system 100A are surrounded by broken lines. The positioning system 100A includes a transmitting and receiving part 110, a main control part 121, a transmitting and receiving process part 122, a distance calculation part 123, an angle calculation part 124, a determining part 125, and a memory 128.

### <Main Control Part 121>

The main control part 121 is a processing part that controls the entire control device 120, and performs processes other than those performed by the transmitting and receiving process part 122, distance calculation part 123, angle calculation part 124, determining part 125, authentication process part 126, and opening and closing control part 127.

### <Transmitting and Receiving Process Part 122>

The transmitting and receiving process part 122 transmits and receives signals to and from the transmitting and receiving process part 222 of the smartphone 200, in order to acquire the data that is needed when the distance calculation part 123 and angle calculation part 124 of the access control system 100 execute the distance calculation process and angle calculation process, such as signals' round trip time, phase differences, frequency components, and so forth. According to the present embodiment, for example, the distance calculation process for calculating the distance between the transmitting and receiving part 110 of the access control system 100 and the smartphone 200 is executed by the distance calculation part 123 of the access control system 100. Also, the angle calculation process for calculating angles that indicate the position of the smartphone 200 with respect to the transmitting and receiving part 110 is executed by the angle calculation part 124 of the access control system 100. The transmitting and receiving process part 122 therefore communicates with the transmitting and receiving process part 222 of the smartphone 200 and performs the following processes when the distance calculation part 123 and the angle calculation part 124 execute the distance calculation process and the angle calculation process.

The transmitting and receiving process part 122 transmits and receives signals to and from the transmitting and receiving process part 222 of the smartphone 200 when the distance calculation part 123 performs a TOA (Time of Arrival)-based distance calculation process. In this case, the transmitting and receiving process part 122 may transmit and receive signals using one of the three antennas 111. The transmitting and receiving process part 122 calculates the phases of the signals received from the smartphone 200. Also, the transmitting and receiving process part 122 receives data that represents phases from the smartphone 200. The data representing phases shows, for example, the phase of a signal when the signal is received by the antenna 211 of the smartphone 200.

Also, when the angle calculation part 124 performs the AOA (Angle of Arrival)-based angle calculation process, the transmitting and receiving process part 122 receives signals from the smartphone 200 by the three antennas 111, calculates their phase differences when the signals are received by the three antennas 111, and transmits data representing the calculated phase differences to the determining part 125. Note that, when the AOA-based angle calculation process is performed, the three antennas 111 receive the signals transmitted from the transmitting and receiving process part 222 of the smartphone 200 for TOA-based distance-calculation, so that the transmitting and receiving process part 122 can transmit and receive the signals for TOA-based distance-calculation, and receive the signals for AOA-based angle calculation, all at the same time.

### <Distance Calculation Part 123>

The distance calculation part 123 can execute a TOA-based distance calculation process. To execute the TOA-based distance calculation process, the distance calculation part 123 acquires the data that indicates the phase difference of each of multiple frequencies from the transmitting and receiving process part 122, and calculates the distance between the transmitting and receiving part 110 of the access control system 100 and the smartphone 200 based on the relationships between the multiple phase differences and the frequencies. The distance between the transmitting and receiving part 110 of the access control system 100 and the smartphone 200 is, for example, the distance between the center of gravity of the three antennas 111 of the transmitting and receiving part 110 and the antenna 211 of the smartphone 200. The distance calculated based on TOA method is significantly more accurate than the distance calculated based on the signal intensity of signals such as RSSI.

### <Angle Calculation Part 124>

The angle calculation part 124 can execute an angle calculation process for calculating the angle of elevation and azimuth in the polar coordinate system of the position of the smartphone 200 with respect to the transmitting and receiving part 110 of the access control system 100, by using the three antennas 111, based on AOA method.

To be more specific, the angle calculation part 124 calculates the angle of elevation and azimuth based on AOA method, based on the phase differences when signals transmitted from the smartphone 200 are received by the three antennas 111. The phase differences of the signals received by the three antennas 111 refer to the first phase difference between signals received by the two antennas 111 located on the first axis and the second phase difference between signals received by the two antennas 111 located on the second axis. The angle calculation part 124 calculates the azimuth, which indicates the position of the smartphone 200 with respect to the transmitting and receiving part 110, from the ratio between the first phase difference and the second phase difference. Also, the angle calculation part 124 calculates the angle of elevation, which indicates the position of the smartphone 200 with respect to the transmitting and receiving part 110, based on the azimuth and the first phase difference or the second phase difference. In the AOA-based angle calculation process, the angle of elevation and azimuth of the position of the smartphone 200 in the polar coordinate system with respect to the transmitting and receiving part 110 can be calculated. To be more specific, the position of the smartphone 200 with respect to the transmitting and receiving part 110 refers to the position of the antenna 211 of the smartphone 200 with respect to the position of the center of gravity of the three antennas 111 of the transmitting and receiving part 110.

### <Determining Part 125>

The determining part 125 determines whether or not the smartphone 200 is approaching the automatic gates 11 to 13 based on the distance calculated by the distance calculation part 123 and the angles calculated by the angle calculation part 124. To be more specific, the determining part 125 determines whether the smartphone 200 is in any one of the determining areas 11A to 13A in front of the automatic gates 11 to 13, based on position data that is stored in the memory 128 and that indicates the positions of the automatic gates 11 to 13, the distance calculated by the distance calculation part 123, and the angles calculated by the angle calculation part 124. The presence of the smartphone 200 inside the determining area 11A assures that the distance between the smartphone 200 and the automatic gate 11 is within a predetermined distance. This also applies to the determining areas 12A and 13A.

### <Authentication Process Part 126>

The authentication process part 126 executes an authentication process using the identifier of the smartphone 200. Note that the authentication process part 126 may perform an authentication process using biological information of the user 20 (for example, face verification, fingerprint verification, etc.), or perform an authentication process using identification information that the user 20 carries with him/her (employee ID, student ID, etc.). The biological information of the user 20 and the identification information that the user 20 carries with him/her are examples of the identifier of the user 20.

### <Opening and Closing Control Part 127>

The opening and closing control part 127 performs a process for locking and unlocking the automatic gates 11 to 13 on a switching basis. To be more specific, when the determining part 125 determines that the distance between the smartphone 200 and the automatic gate 11 is within a predetermined distance (the smartphone 200 is in the determining area 11A) and the authentication process part 126 determines that the authentication process is successfully completed, the opening and closing control part 127 unlocks the automatic gate 11. The opening and closing control part 127 performs substantially the same process for the automatic gates 12 and 13.

### <Memory 128>

The memory 128 stores the programs and data that are needed when the main control part 121, transmitting and receiving process part 122, distance calculation part 123, angle calculation part 124, determining part 125, authentication process part 126, and opening and closing control part 127 perform their processes.

### <Structure of Smartphone 200>

The smartphone 200 includes an antenna 211, a communication part 215, and an MCU 220. Each antenna 211 is connected to the communication part 215 and receives signals transmitted from the access control system 100. The communication part 215 includes an AFE, an AD converter, and so forth, performs signal processing such as AD conversion on the signals received by the antenna 211, and outputs it to the MCU 220. Note that, although the smartphone 200 illustrated here has only one antenna 211, it may have multiple antennas 211.

### <MCU 220>

The MCU 220 includes a main control part 221, a transmitting and receiving process part 222, and a memory 233.

The main control part 221 and the transmitting and receiving process part 222 represent the functions of programs executed by the MCU 220 as functional blocks. Also, the memory 233 is a functional representation of the memory of the MCU 220.

### <Main Control Part 221>

The main control part 221 is a processing part that controls the entire MCU 220, and performs processes other than those executed by the signal intensity calculation part 232. The main control part 221 executes processes for implementing various functions of the smartphone 200.

### <Transmitting and Receiving Process Part 222>

The transmitting and receiving process part 222 transmits and receives signals to and from the transmitting and receiving process part 122 of the control system 100, in order to acquire the data that is needed when the distance calculation part 123 and the angle calculation part 124 of the access control system 100 perform the distance calculation process and the angle calculation process, such as phase differences, frequency components, and so forth.

When the distance calculation part 123 of the access control system 100 performs a TOA-based distance calculation process, the transmitting and receiving process part 222 and the transmitting and receiving process part 122 of the access control system 100 transmit TOA signals of multiple frequencies to each other bidirectionally. In this case, the transmitting and receiving process part 222 calculates the phases of the TOA signals received from the access control system 100, and transmits data that indicates the phases to the transmitting and receiving process part 122 of the access control system 100. The data that indicates the phases shows the phases of the TOA signals when they are received by the antenna 211 of the smartphone 200.

### <Memory 233>

The memory 233 stores the programs, data, and so forth that are needed when the main control part 221 and the transmitting and receiving process part 222 execute their processes.

### <Determining Area 11A>

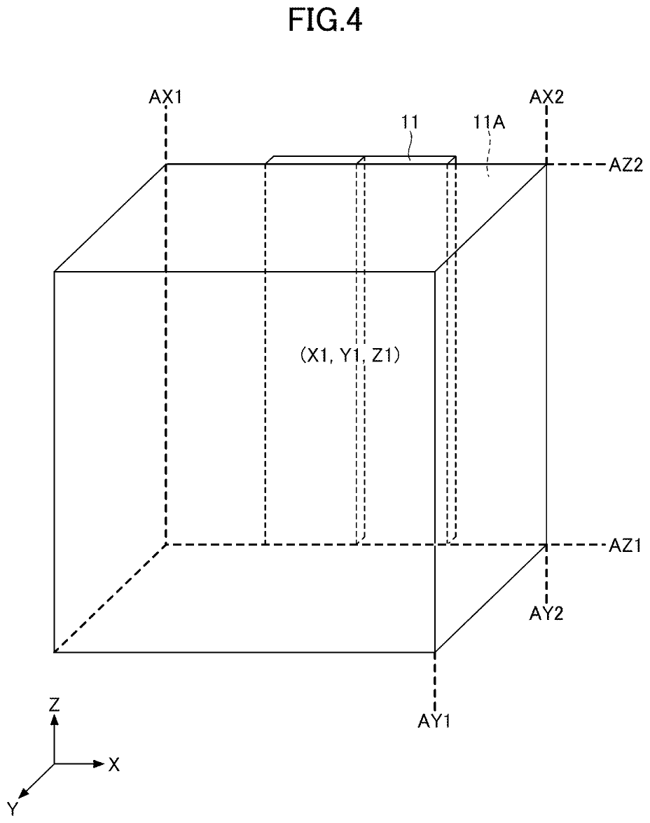

FIG. 4 is a diagram that shows an example of the determining area 11A. FIG. 4 shows the determining area 11A, which is set in front of the automatic gate 11. In FIG. 4, XYZ coordinates are defined.

Also, FIG. 4 shows the reference coordinates (X1, Y1, Z1) of the automatic gate 11. The reference coordinates (X1, Y1, Z1) of the automatic gate 11 are the XYZ coordinates of the reference point of the automatic gate 11. The reference point of the automatic gate 11 is, for example, the coordinates of the center of the automatic gate 11 in the X direction, Y direction, and Z direction. Data to represent these reference coordinates (X1, Y1, Z1) of the automatic gate 11 and data to represent the length of the automatic gate 11 in the X direction, Y direction, and Z direction may be stored in advance in the memory 128.

The determining area 11A is an area in which the X coordinate is greater than a threshold AX1 and less than a threshold AX2, the Y coordinate is greater than a threshold AY1 and less than a threshold AY2, and the Z coordinate is greater than a threshold AZ1 and less than a threshold AZ2. Note that the threshold AX2 is greater than the threshold AX1, the threshold AY2 is greater than the threshold AY1, and the threshold AZ2 is greater than the threshold AZ1. That is, insofar as the XYZ coordinates of the smartphone 200 hold in accordance with AX1<X<AX2, AY1<Y<AY2, and AZ1<Z<AZ2, it then follows that the smartphone 200 is present in the determining area 11A.

These thresholds AX1, AX2, AY1, AY2, AZ1, and AZ2 are set likewise with respect to the determining areas 12A and 13A. Note that, for the determining area 12A, thresholds BX1, BX2, BY1, BY2, BZ1, and BZ2 are set, and thresholds CX1, CX2, CY1, CY2, CZ1, and CZ2 are set for the determining area 13A.

### <Flowchart>

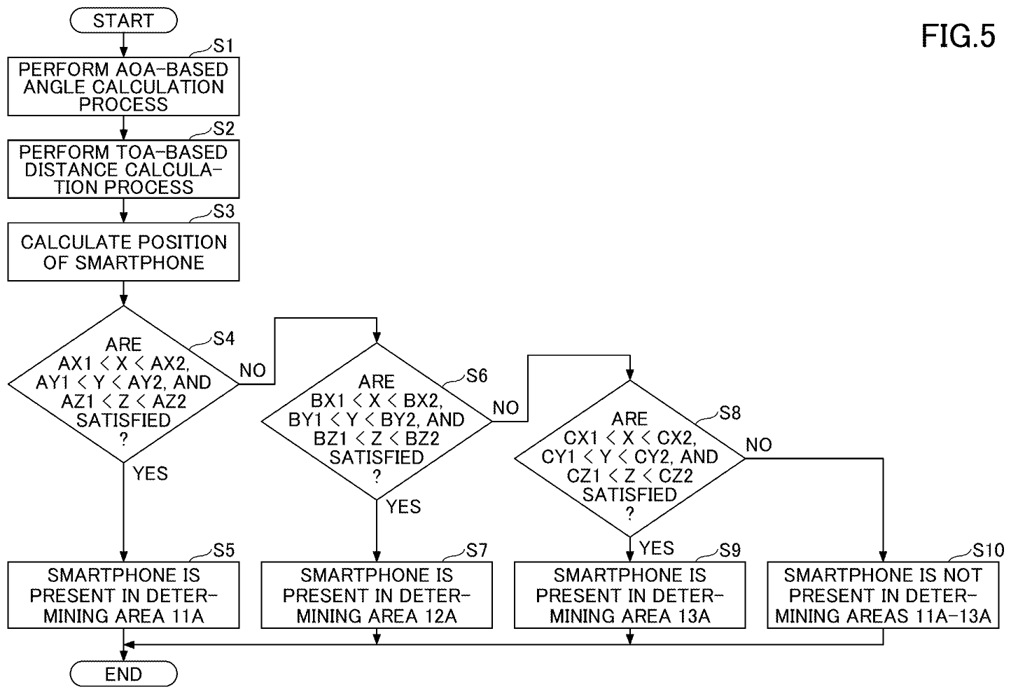

FIG. 5 is a flowchart that shows examples of process steps (part 1) executed by the control device 120 of the access control system 100. FIG. 5 shows the process steps executed by the transmitting and receiving process part 122, distance calculation part 123, angle calculation part 124, and determining part 125, in relationship to the positioning system 100A of the control device 120 of the access control system 100.

When the process steps start, the transmitting and receiving process part 122 performs the transmitting and receiving process of TOA signals with the transmitting and receiving process part 222 of the smartphone 200. The angle calculation part 124 performs an AOA-based angle calculation process (step S1).

The distance calculation part 123 performs a TOA-based distance calculation process (step S2).

The determining part 125 determines the XYZ coordinates of the smartphone 200 by using the angles (elevation angle φ and azimuth θ) determined in the angle calculation process, and the distance r determined in the distance calculation process (step S3). Note that the XYZ coordinates can be determined as follows by using the angles (elevation angle φ and azimuth θ) and the distance r: X=rsin θ cos φ, Y=rsin θ sin φ, and Z=rcosθ.

The determining part 125 determines whether or not the XYZ coordinates of the smartphone 200 hold in accordance with AX1<X<AX2, AY1<Y<AY2, and AZ1<Z<AZ2 (step S4).

If the determining part 125 determines that the XYZ coordinates of the smartphone 200 hold in accordance with AX1<X<AX2, AY1<Y<AY2, and AZ1<Z<AZ2 (S4: YES), the determining part 125 determines that the smartphone 200 is present in the determining area 11A (step S5).

If, in step S4, the determining part 125 determines that the XYZ coordinates of the smartphone 200 do not hold in accordance with AX1<X<AX2, AY1<Y<AY2, and AZ1<Z<AZ2 (S4: NO), the determining part 125 determines whether or not the XYZ coordinates of the smartphone 200 hold in accordance with BX1<X<BX2, BY1<Y<BY2, and BZ1<Z<BZ2 (step S6).

If the determining part 125 determines that the XYZ coordinates of the smartphone 200 hold in accordance with BX1<X<BX2, BY1<Y<BY2, and BZ1<Z<BZ2 (S6: YES), the determining part 125 determines that the smartphone 200 is present in the determining area 12A (step S7).

Also, if, in step S6, the determining part 125 determines that the XYZ coordinates of the smartphone 200 do not hold in accordance with BX1<X<BX2, BY1<Y<BY2, and BZ1<Z<BZ2 (S6: NO), the determining part 125 determines whether or not the XYZ coordinates of the smartphone 200 hold in accordance with CX1<X<CX2, CY1<Y<CY2, and CZ1<Z<CZ2 (step S8).

When the determining part 125 determines that the XYZ coordinates of the smartphone 200 hold in accordance with CX1<X<CX2, CY1<Y<CY2, and CZ1<Z<CZ2 (S8: YES), the determining part 125 determines that the smartphone 200 is present in the determining area 13A (step S9).

Also, if, in step S9, the determining part 125 determines that the XYZ coordinates of the smartphone 200 do not hold in accordance with CX1<X<CX2, CY1<Y<CY2, and CZ1<Z<CZ2 (S8: NO), the determining part 125 determines that the smartphone 200 is not present in the determining areas 11A to 13A (step S10). That is, although the smartphone 200 is in the room 10R, the smartphone 200 is determined not to be present in any of the determining areas 11A to 13A.

This completes the series of process steps. The process shown in FIG. 5 is repeated in a predetermined control cycle.

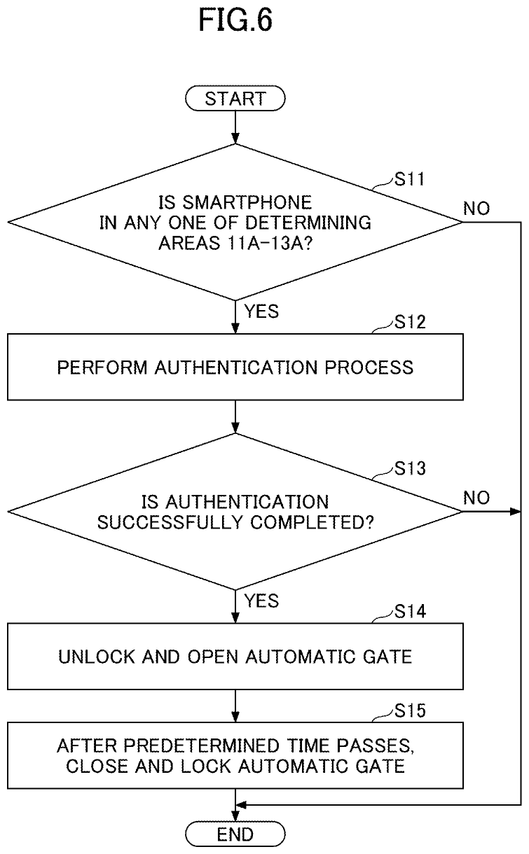

FIG. 6 is a flowchart that shows examples of process steps (part 2) executed by the control device of the access control system.

The determining part 125 determines whether or not the smartphone 200 is present in any one of the determining areas 11A to 13A (step S11). The determining part 125 determines whether or not the smartphone 200 is present in any of the determining areas 11A to 13A based on the determination results of steps S5, S7, S9, and S10.

When the determining part 125 determines that the smartphone 200 is present in one of the determining areas 11A to 13A (S11: YES), the authentication process part 126 performs an authentication process by using the identifier of the smartphone 200 (step S12).

The authentication process part 126 determines whether or not the authentication by the authentication process is successfully completed (step S13).

When the authentication process part 126 determines that the authentication by the authentication process is successfully completed (S13: YES), the opening and closing control part 127 unlocks and opens the automatic gate 11, 12, or 13 that corresponds to the determining area (one of the determining areas 11A to 13A) where the smartphone 200 is determined to be present (step S14).

When a predetermined period of time passes after the smartphone 200 moves out of the positioning target area 10A through the automatic gate (one of the automatic gates 11 to 13), the opening and closing control part 127 closes and locks the automatic gate (step S15). This is to prevent users who are not successfully authenticated from entering or exiting the place. The predetermined time is, for example, approximately 1 to 2 seconds.

This completes the series of process steps (END). The process shown in FIG. 6 is repeated in a predetermined control cycle.

Note that if, in step S11, the determining part 125 determines that the smartphone 200 is not present in any of the determining areas 11A to 13A (S11: NO), the series of process steps may be ended here (END). In this case, the process ends without opening any of the automatic gates 11 to 13.

Also, if, in step S13, the authentication in the authentication process part 126 is not successfully completed (S13: NO), the series of process steps may be ended here (END). If the authentication is not successfully completed, the process ends without opening any of the automatic gates 11 to 13.

### <Effects>

The positioning system 100A includes: a transmitting and receiving part 110 that has multiple antennas 111 and is positioned overhead in a positioning target area 10A where automatic gates 11 and 12 are provided; a distance calculation part 123 that calculates the distance between a smartphone 200, which can move inside the positioning target area 10A, and the transmitting and receiving part 110, based on results gained from signals of multiple frequencies transmitted bidirectionally between the mobile smartphone 200 and the transmitting and receiving part 110; an angle calculation part 124 that calculates angles that indicate the position of the smartphone 200 with respect to the transmitting and receiving part 110, based on phase differences between the signals that the multiple antennas 111 of the transmitting and receiving part 110 receive from the smartphone 200; and a determining part 125 that determines whether or not the smartphone 200 is approaching the automatic gates 11 and 12, based on the distance calculated by the distance calculation part 123 and the angles calculated by the angle calculation part 124.

Therefore, by means of the TOA-based distance calculation process and the AOA-based angle calculation process, whether or not the smartphone 200 is approaching the automatic gates 11 and 12 can be determined accurately. In particular, the TOA-based distance calculation process is affected less by the impact of multi-path signals and the like, and therefore enables accurate distance calculation compared to a distance calculation process based on signal intensity such as RSSI.

Therefore, it is possible to provide a positioning system 100A whereby the position of the smartphone 200 can be calculated accurately. Also, provided that the access control system 100 includes a positioning system 100A, it is possible to provide an access control system 100 whereby the position of the smartphone 200 can be calculated accurately.

Also, the access control system 100 further includes a memory 128 that stores position data that indicates the positions of the automatic gates 11 and 12, and the determining part 125 determines whether or not the smartphone 200 is approaching the automatic gates 11 and 12 based on the position data, the distance calculated by the distance calculation part 123, and the angles calculated by the angle calculation part 124.

Consequently, it is possible to provide a positioning system 100A whereby, by using the position data that indicates the positions of the automatic gates 11 and 12, the position of the smartphone 200 with respect to the automatic gates 11 and 12 can be calculated more accurately.

Also, the access control system 100 includes: a positioning system 100A; an authentication process part 126 that can execute an authentication process by using an identifier of the smartphone 200 or an identifier of a moving object that can move with the smartphone 200; and an opening and closing control part 127 that locks and unlocks the automatic gates 11 and 12 on a switching basis, and, in this access control system 100, when the determining part 125 determines that the distance between the smartphone 200 and the automatic gate 11 or 12 is within a predetermined distance, and the authentication process part 126 determines that the authentication process by the authentication process part 126 is successfully completed, the opening and closing control part unlocks the automatic gate 11 or 12.

Therefore, it is possible to provide an access control system 100 whereby, when authentication is successfully completed, the automatic gates 11 or 12 can be unlocked by using an accurately calculated position of the smartphone 200 with respect to the automatic gates 11 and 12.

Also, in the access control system 100, when a predetermined period of time passes after the smartphone 200 moves out of the positioning target area 10A through the automatic gate 11 or 12, the opening and closing control part 127 locks the gate.

Therefore, by using an accurately calculated position of the smartphone 200 with respect to one of the automatic gates 11 to 13, when a predetermined period of time passes after the smartphone 200 moves out of the positioning target area 10A through one of the automatic gates 11 to 13, the gate that is open can be locked. Consequently, it is possible to provide an access control system 100, whereby the entry and exit of users can be controlled accurately by using accurately calculated positions of smartphones 200 with respect to any of the automatic gates 11 to 13, and whereby the entry and exit of unauthorized persons can be strictly prevented.

A positioning method for use in a positioning system 100A including: a transmitting and receiving part 110 that has multiple antennas 111 and is positioned overhead in a positioning target area 10A where automatic gates 11 and 12 are provided; a distance calculation part 123 that calculates the distance between a smartphone 200, which can move inside the positioning target area 10A, and the transmitting and receiving part 110, based on results gained from signals multiple of frequencies transmitted bidirectionally between the mobile smartphone 200 and the transmitting and receiving part 110; and an angle calculation part 124 that calculates angles that indicate the position of the smartphone 200 with respect to the transmitting and receiving part 110, based on phase differences between the signals that the multiple antennas 111 of the transmitting and receiving part 110 receive from the smartphone 200, determines whether or not the smartphone 200 is approaching the automatic gate 11 or 12 based on the distance calculated by the distance calculation part 123 and the angles calculated by the angle calculation part 124.

Therefore, it is possible to accurately determine whether or not the smartphone 200 is approaching the automatic gates 11 and 12, based on the TOA-based distance calculation process and the AOA-based angle calculation process. In particular, the TOA-based distance calculation process is affected less by the impact of multi-path signals and the like, and enables accurate distance calculation compared to a distance calculation process based on signal intensity such as RSSI.

Therefore, it is possible to provide a positioning method whereby the position of the smartphone 200 can be calculated accurately.

Now, although examples of the positioning system, access control system, and positioning method of the present disclosure have been described above, the present disclosure is by no means limited to the examples described in detail herein, and a variety of alterations and changes can be made without departing from the scope of the claims attached herewith.

What is claimed is:

1. A positioning system comprising:
a transmitting and receiving part having a plurality of antennas and positioned overhead in a positioning target area where there is a side entrance;
a distance calculation part configured to calculate a distance between a communication device that can move in the positioning target area, and the transmitting and receiving part, based on results gained from signals of a plurality of frequencies transmitted bidirectionally between the communication device and the transmitting and receiving part;
an angle calculation part configured to calculate an angle that indicates a position of the communication device with respect to the transmitting and receiving part, based on a phase difference between the signals received by the plurality of antennas of the transmitting and receiving part; and
a determining part configured to determine whether or not the communication device is approaching the side entrance based on the distance calculated by the distance calculation part and the angle calculated by the angle calculation part.

2. The positioning system according to claim 1,
further comprising a storage part configured to store position data that indicates a position of the side entrance,
wherein the determining part determines whether or not the communication device is approaching the side entrance based on the position data, the distance calculated by the distance calculation part, and the angle calculated by the angle calculation part.

3. An access control system comprising:
the positioning system of claim 1;
an authentication process part configured to execute an authentication process by using an identifier of the communication device or an identifier of a moving body that can move with the communication device; and
a locking and unlocking part configured to lock and unlock, on a switching basis, a gate that is provided at the side entrance,
wherein, when the determining part determines that the distance between the communication device and the side entrance is within a predetermined distance and that the authentication process by the authentication process part is successfully completed, the locking and unlocking part unlocks the gate.

4. The access control system according to claim 3, wherein, when a predetermined period of time passes after the communication device moves out of the positioning target area through the side entrance, the locking and unlocking part locks the gate.

5. A positioning method for use in a positioning system including:
a transmitting and receiving part having a plurality of antennas and positioned overhead in a positioning target area where there is a side entrance;
a distance calculation part configured to calculate a distance between a communication device that can move in the positioning target area, and the transmitting and receiving part, based on results gained from signals of a plurality of frequencies transmitted bidirectionally between the communication device and the transmitting and receiving part; and
an angle calculation part configured to calculate an angle that indicates a position of the communication device with respect to the transmitting and receiving part, based on a phase difference between the signals received by the plurality of antennas of the transmitting and receiving part,
the positioning method comprising determining whether or not the communication device is approaching the side entrance based on the distance calculated by the distance calculation part and the angle calculated by the angle calculation part.
